(19) United States
(12) Patent Application Publication
(10) Pub. No.: US 2026/0178246 A1
(43) Pub. Date: Jun. 25, 2026

(54) MANAGEMENT APPARATUS THAT CENTRALLY MANAGES PLURALITY OF IMAGE FORMING APPARATUSES

(71) Applicant: KYOCERA Document Solutions Inc., Osaka (JP)

(72) Inventors: Jaclyn Tiffanie TAN, Osaka (JP); Samuel PALACIOS, Osaka (JP); Nino Conrad ROSAL, Osaka (JP)

(73) Assignee: KYOCERA Document Solutions Inc., Osaka (JP)

(21) Appl. No.: 19/413,213

(22) Filed: Dec. 9, 2025

(30) Foreign Application Priority Data
Dec. 19, 2024 (JP) 2024-224508

(51) Int. Cl. G06F 3/12

(52) U.S. Cl. CPC G06F 3/1222; G06F 3/1231; G06F 3/1238; G06F 3/1285

(57) ABSTRACT

A management apparatus centrally manages a plurality of image forming apparatuses via a network. The management apparatus includes a communication device and a control device. The communication device communicates with the outside through the network. The control device includes a processor, and when the processor executes a control program, functions as an acquisition device and a controller. The acquisition device acquires a combination group having at least one piece of unit information having a combination of identification information used for identifying the image forming apparatus and authentication information as one set. The controller extracts the authentication information combined with the identification information on the basis of the combination group acquired by the acquisition device, transmits the extracted authentication information to the image forming apparatus corresponding to this identification information through the communication device, and transmits an instruction for requesting update of the authentication information to this image forming apparatus.

### INCORPORATION BY REFERENCE

This application claims priority to Japanese Patent Application No. 2024-224508 filed on Dec. 19, 2024, the entire contents of which are incorporated by reference herein.

### BACKGROUND

The present disclosure relates to a management apparatus that centrally manages a plurality of image forming apparatuses.

A system in which a plurality of image forming apparatuses such as multifunction devices are managed using a management apparatus via a network is known. Since the management apparatus can centrally manage the image forming apparatuses on the network, it becomes possible to efficiently perform setting of each image forming apparatus, ordering of consumables, and managing of inventory, and the like.

### SUMMARY

As one aspect of the present disclosure, a technology that further improves the technology described above is proposed.

A management apparatus according to one aspect of the present disclosure is a management apparatus centrally managing a plurality of image forming apparatuses via a network. The management apparatus includes a communication device and a control device. The communication device communicates with the outside through the network. The control device includes a processor, and when the processor executes a control program, functions as an acquisition device and a controller. The acquisition device acquires a combination group having at least one piece of unit information having a combination of identification information used for identifying the image forming apparatus and authentication information as one set. The controller extracts the authentication information combined with the identification information on the basis of the combination group acquired by the acquisition device, transmits the extracted authentication information to the image forming apparatus corresponding to this identification information through the communication device, and transmits an instruction for requesting update of the authentication information to this image forming apparatus.

### BRIEF DESCRIPTION OF THE DRAWINGS

FIG. 1 is a diagram illustrating an entire information processing system configured to include a management apparatus according to one embodiment of the present disclosure.

FIG. 2 is a functional block diagram schematically illustrating a major internal configuration of the management apparatus according to one embodiment of the present disclosure.

FIG. 3 is a diagram illustrating a CSV file as an example.

FIG. 4 is a diagram illustrating an example of an operation screen displayed on a display device.

FIG. 5 is a diagram illustrating an example of an operation screen displayed on the display device.

FIG. 6 is a diagram illustrating an example of an operation screen displayed on the display device.

FIG. 7 is a flowchart illustrating an example of a process relating to the update of an authentication password using the management apparatus.

### DETAILED DESCRIPTION

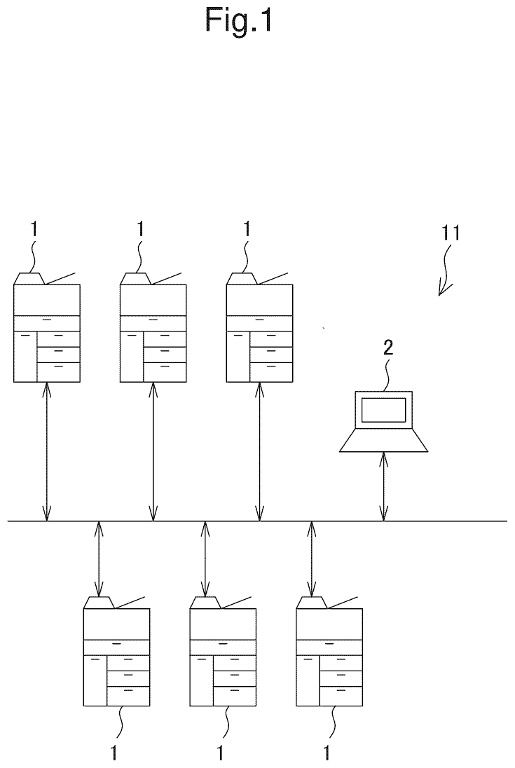

FIG. 1 is a diagram illustrating an entire information processing system configured to include a management apparatus according to one embodiment of the present disclosure.

An information processing system 11 according to an embodiment is configured to include a plurality of image forming apparatuses 1 and a management apparatus 2 connected to each other using a network such as the Internet. The image forming apparatus 1, for example, is a multi-function device having a plurality of functions such as a copy function, a printer function, a scanner function, and a facsimile function. The management apparatus 2, for example, is a computer and centrally manages the plurality of image forming apparatuses 1 through a network.

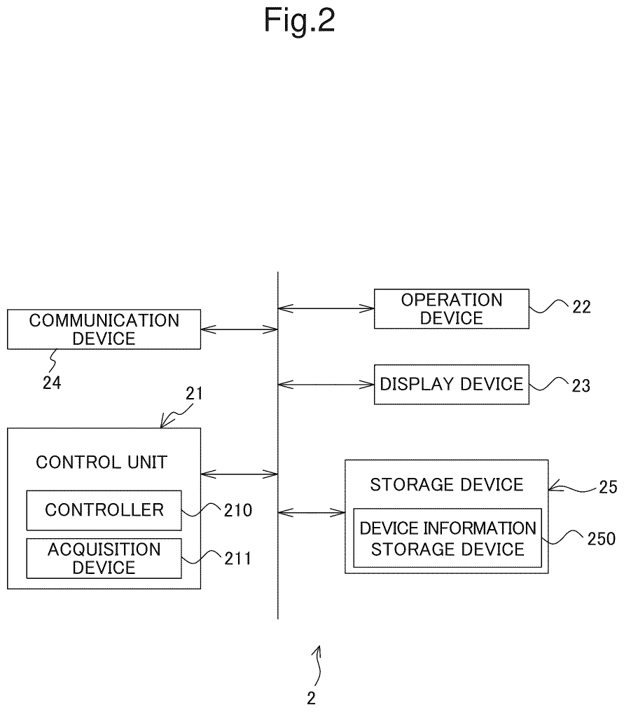

FIG. 2 is a functional block diagram schematically illustrating a major internal configuration of the management apparatus 2 according to one embodiment of the present disclosure. The management apparatus 2 includes a control unit 21, an operation device 22, a display device 23, a communication device 24, and a storage device 25. Such components are able to mutually transmit/receive data or signals using a communication bus.

The operation device 22 is configured using a keyboard, a mouse, and the like, inputs a command and text to the control unit 21, and further operates a pointer on the screen of the display device 23. The operation device 22 receives an input of an instruction from a user that is based on a user's operation. The display device 23 is configured using a liquid crystal display (LCD) and the like and displays a response and a data result from the control unit 21.

The communication device 24 communicates with the outside via a network. For example, the communication device 24 is a communication interface that transmits/receives various kinds of data to/from an external device such as the image forming apparatus 1 and the like inside a local area or on the Internet.

The storage device 25 is a large-capacity storage device such as a hard disk drive (HDD) or a solid state drive (SSD) and stores various kinds of control programs and the like. The storage device 25 has a device information storage device 250.

The device information storage device 250 is an area in which device information of the image forming apparatus 1 that is a management target for the management apparatus 2 is stored. In the device information storage device 250, as the device information of the image forming apparatus 1, identification information (for example, a serial number) for identifying the image forming apparatus 1, destination information (for example, an IP address) representing the destination of the image forming apparatus 1, and authentication information (for example, an authentication password) for using the function of the image forming apparatus 1 are stored in association with each other. Alternatively, the authentication information may be authentication information used for authentication that the image forming apparatus 1 accesses the management apparatus 2 and receives management services provided by the functions of the management apparatus 2.

The control unit 21 is configured to include a processor, a random access memory (RAM), a read only memory (ROM), and a dedicated hardware circuit. The processor, for example, is a central processing unit (CPU), an application specific integrated circuit (ASIC), a micro processing unit (MPU), or the like. The control unit 21 includes a controller 210 and an acquisition device 211.

The control unit 21 functions as a controller 210 and an acquisition device 211 in accordance with an operation using the above-described processor according to a control program stored in the storage device 25. However, each of the controller 210 and the like can be configured using a hardware circuit without using an operation according to a control program or the like that is performed by the control unit 21. Hereinafter, unless otherwise mentioned, this similarly applies to each embodiment.

The controller 210 is responsible for overall operation control of the management apparatus 2. The controller 210 is connected to the operation device 22, the display device 23, the communication device 24, and the storage device 25 and performs drive control and the like of these devices.

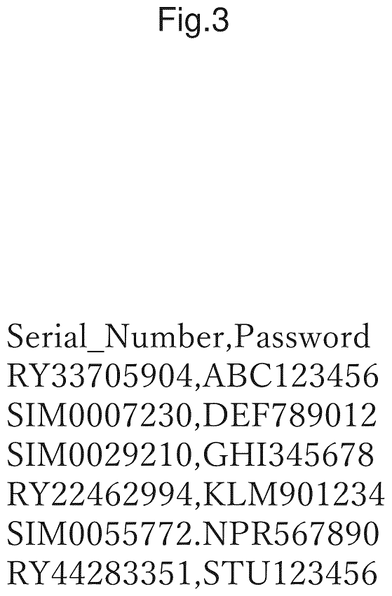

The acquisition device 211 acquires a combination group having at least one combination of one piece of identification information (for example, a serial number) for identifying the image forming apparatus 1 and one piece of authentication information (for example, an authentication password). Such a combination group, for example, is acquired as a CSV file. FIG. 3 is a diagram illustrating details of this CSV file as an example.

As an example, the CSV file illustrated in FIG. 3 includes six combinations each having two data items including the serial number “Serial Number” of the image forming apparatus 1 and an authentication password “Password” that is necessary for using the functions of the image forming apparatus 1, or for the image forming apparatus 1 to access the management apparatus 2 and receive management services from the management apparatus 2 as one set. A first row that is a leading row is a title row, and the data items are separated by commas. In a second row and subsequent rows, serial numbers and authentication passwords are specifically recorded.

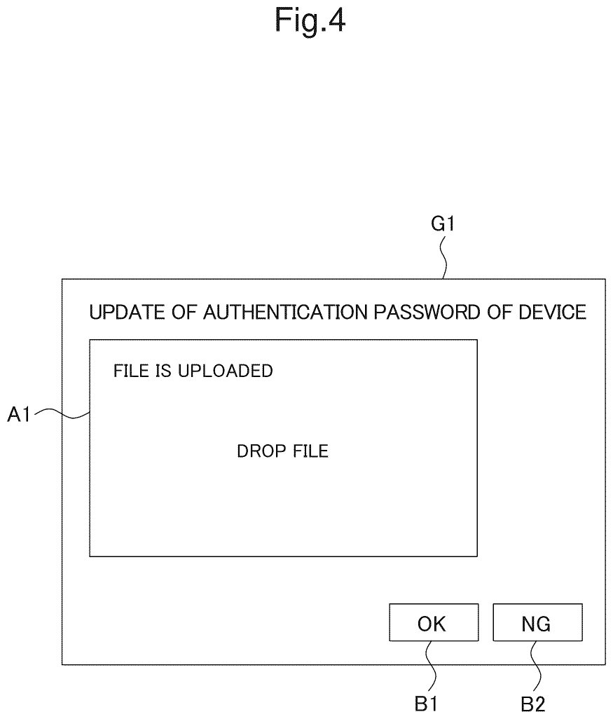

FIG. 4 is a diagram illustrating an example of an operation screen that is used for the acquisition device 211 to acquire a file. In the operation screen G1 displayed on the display device 23, a drop area A1 used for dropping a file, an operation button B1 marked “OK”, and an operation button B2 marked “NG” are displayed. In the drop area A1, a file as illustrated in FIG. 3 is dropped in accordance with an operation on the operation device 22, or when an instruction for designating a file is input to the operation device 22, the controller 210 receives this file as an acquisition target and displays an image representing this file regarded as the acquisition target in the drop area A1. The acquisition device 211 acquires this file regarded as the acquisition target.

When the acquisition device 211 acquires a combination group, the controller 210 causes the display device 23 to display a confirmation screen on which identification information and authentication information of each combination included in this combination group are displayed to be aligned. In accordance with this, a user is enabled to confirm the authentication information that is a target for update. At the time of display, when the operation device 22 receives a permission instruction for permitting the update of the authentication information from a user, the controller 210 transmits an instruction for requesting update of the authentication information to the corresponding image forming apparatus 1 through the communication device 24.

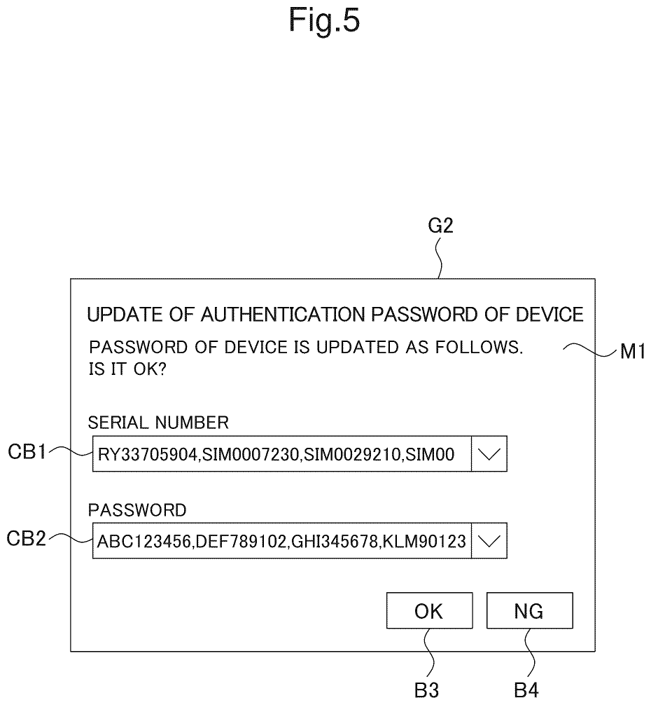

FIG. 5 is a diagram illustrating an example of the above-described confirmation screen displayed on the display device 23. On the operation screen G2 that is a confirmation screen, a message M1 “The password of the device is updated as follows. Is it OK?” and combo boxes CB1 and CB2 are displayed, and an operation button B3 marked “OK” used for a user to accept an update instruction for approving update and an operation button B4 used for accepting a rejection instruction for a user not to approve the update are displayed.

Under control performed by the controller 210, serial numbers are displayed in the order of description in the CSV file in the combo box CB1, and authentication passwords are displayed in the order of description in the CSV file in the combo box CB2. At this time, when a change instruction for changing the serial number and the authentication password is input to the operation device 22 in accordance with a user's operation, the controller 210 changes the serial number and the authentication password displayed in the combo boxes CB1 and CB2 in accordance with this change instruction.

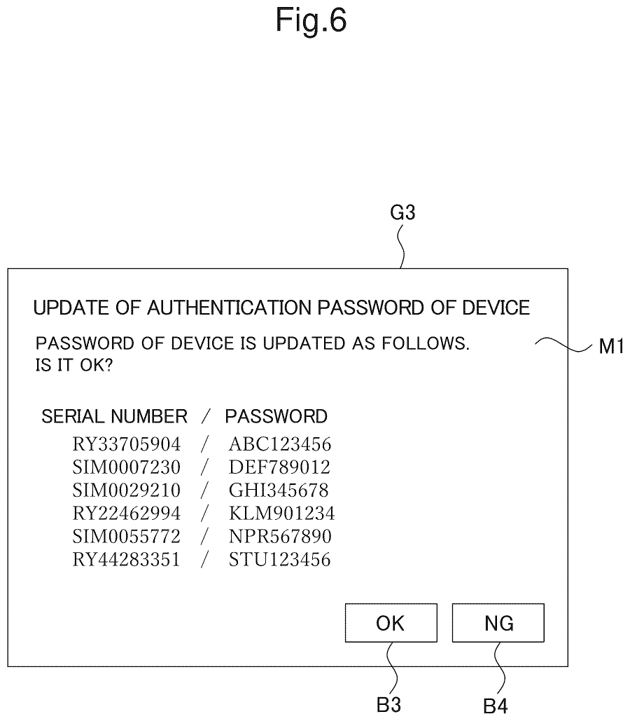

FIG. 6 is a diagram illustrating another example of the above-described confirmation screen displayed on the display device 23. Under the control of the display device 23 that is performed by the controller 210, although serial numbers and authentication passwords are separately displayed to be aligned on the operation screen G2 displayed as a confirmation screen, on an operation screen G3 that is a configuration screen illustrated in FIG. 6, combinations each having a serial number and an authentication password as one set are displayed to be aligned, which is different from the operation screen G2.

When the operation button B2 on the operation screens G2 and G3 is operated by a user, and the update instruction described above is input to the operation device 22, the controller 210 extracts a combination of identification information (serial number) and authentication information (authentication password) combined therewith from a combination group included in the above-described file acquired by the acquisition device 211. The controller 210 transmits this extracted authentication information to the image forming apparatus 1 corresponding to the extracted identification information through the communication device 24 and transmits an instruction for requesting update of the authentication information to this image forming apparatus 1. In addition, when the operation button B4 on the operation screen G2 and G3 is operated by a user, and a non-update instruction is input to the operation device 22, the controller 210 deletes the acquired file and ends the process without performing the process of extracting the combination described above.

For example, by referring to the device information storage device 250, the controller 210 transmits an instruction for requesting execution of a process of reading the IP address of the image forming apparatus 1 corresponding to the serial number, transmitting an authentication password corresponding to this serial number (combined with this serial number) to the image forming apparatus 1 represented by the IP address through the communication device 24, and updating the authentication password up to now with an authentication password to be newly transmitted this time.

In accordance with the instruction for the request described above from the management apparatus 2 (the controller 210), the image forming apparatus 1 performs the process of updating the authentication password up to now with an authentication password to be newly transmitted this time. For example, the image forming apparatus 1 performs data verification of whether the authentication password that has been newly received from the management apparatus 2 is appropriate and, when it is determined that the authentication password is appropriate, updates the authentication password by rewriting the authentication password up to now with the authentication password to be newly transmitted this time. In addition, the controller (the CPU or the like) of the image forming apparatus 1 transmits a notification indicating “success” to the management apparatus 2 through the communication device included in the image forming apparatus 1 in a case in which the update of the authentication password has been appropriately completed (that is, in the case of a success) and transmits a notification indicating “failure” to the management apparatus 2 in a case in which the update of the authentication password has not been appropriately completed (that is, in the case of a failure).

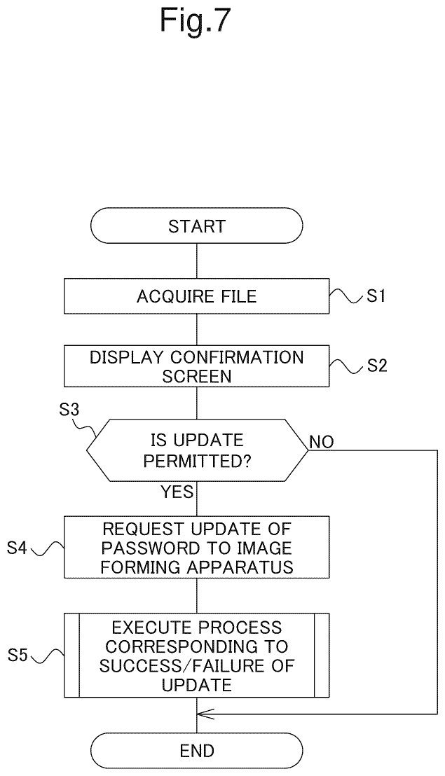

Next, an example of the process relating to the update of the authentication password that is performed by the management apparatus 2 is described with reference to a flowchart illustrated in FIG. 7.

When the acquisition device 211 acquires a file as illustrated in FIG. 3 as an example (S1), the controller 210 causes the display device 23 to display the operation screen G2 as illustrated in FIG. 5 as an example on the basis of a combination group included in the file acquired by the acquisition device 211 (S2). In accordance with this, a user can confirm that the authentication password is updated.

When the update instruction described above is input to the operation device 22 in accordance with a user's operation on the operation button B3 (Yes in S3), the controller 210 extracts a combination of identification information (serial number) and authentication information (authentication password) combined therewith from a combination group included in the file described above through the communication device 24, transmits this extracted authentication information to the image forming apparatus 1 corresponding to this extracted identification information, and transmits an instruction for requesting the update of the authentication information to this image forming apparatus 1 (S4). On the other hand, in a case in which the non-update instruction described above is input to the operation device 22 in accordance with a user's operation on the operation button B4 (No in S3), the controller 210 deletes the acquired file described above and ends the process.

After S4, the controller 210 executes a process corresponding to the notification of “success” or “failure” transmitted from the image forming apparatus 1 (S5). For example, in a case in which the notification of “success” has been received from all the image forming apparatuses 1 that requested update of the authentication password, the controller 210 causes the display device 23 to display a message that indicates that the update of the password has been appropriately completed. On the other hand, in a case in which the notification of “failure” has been received from one or more image forming apparatuses 1, the controller 210 displays a message that indicates that the update of the password has not been appropriately completed on the display device 23 and displays the serial number of the image forming apparatus 1 that has notified “failure” on the display device 23 on the basis of details stored in the device information storage device 250.

According to the embodiment described above, since update of authentication information (authentication passwords) in a plurality of image forming apparatuses 1 can be simultaneously performed, the update of the authentication information in the image forming apparatuses 1 can be efficiently performed.

When there are cases in which authentication information (authentication password) becomes necessary in order for a general image forming apparatus not according to the above embodiment to use the function of the management apparatus, a manager performs an operation necessary for updating an authentication password for each of image forming apparatuses by operating the management apparatus. For this reason, when there are image forming apparatuses that are management targets, the operation time of the manager becomes long, and the burden of the manager is large, and the efficiency is low. Although a technology of rendering of data is known, the technology is not used for efficiently updating an authentication password. In contrast to this, according to the above embodiment, the authentication information can be updated efficiently in the image forming apparatus 1.

The present disclosure is not limited to the configuration of the embodiment described above, and various modifications can be made. In the embodiment described above, the configuration and the process illustrated in the embodiment with reference to FIGS. 1 to 7 are merely those of one embodiment of the present disclosure and are not intended to limit the present disclosure to the configuration and the process.

While the present disclosure has been described in detail with reference to the embodiments thereof, it would be apparent to those skilled in the art that the various changes and modifications may be made therein within the scope defined by the appended claims. Naturally, it should be understood that the present disclosure is not limited to the exemplary embodiment described in this specification. What is claimed is;

1. A management apparatus centrally managing a plurality of image forming apparatuses via a network, the management apparatus comprising:
a communication device that communicates with the outside through the network;
a control device that includes a processor, and when the processor executes a control program, functions as
an acquisition device that acquires a combination group having at least one piece of unit information having a combination of identification information used for identifying the image forming apparatus and authentication information as one set; and
a controller that extracts the authentication information combined with the identification information on the basis of the combination group acquired by the acquisition device, transmits the extracted authentication information to the image forming apparatus corresponding to this identification information through the communication device, and transmits an instruction for requesting update of the authentication information to this image forming apparatus.

2. The management apparatus according to claim 1, wherein the combination group is a file of a comma separated value (CSV) format.

3. The management apparatus according to claim 1, further comprising:
a display device; and
an operation device that receives an input of an instruction from a user,
wherein the controller:
causes the display device to display a confirmation screen in which the identification information and the authentication information are displayed to be aligned on the basis of the combination group acquired by the acquisition device; and
transmits an instruction for requesting update of the authentication information to the image forming apparatus through the communication device when the operation device receives a permission instruction for permitting the update of the authentication information displayed on the display device.

4. The management apparatus according to claim 1, further comprising:
a display device,
wherein the controller:
causes the display device to display a message indicating completion of update the authentication information when the communication device receives an information indicating that the authentication information has been updated from the image forming apparatus that has transmitted an instruction requesting update of the authentication information, and
causes the display device to display a message indicating that the authentication information update was not completed when the communication device receives an information indicating that the authentication information has not been updated from the image forming apparatus that has transmitted the instruction requesting update of the authentication information.
